(19) United States
(12) Patent Application Publication
(10) Pub. No.: US 2002/0037751 A1
(43) Pub. Date: Mar. 28, 2002

(54) Portable terminal and control method thereof

(76) Inventor: Kazuhiro Nagase, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/949,653

(22) Filed: Sep. 12, 2001

(30) Foreign Application Priority Data
Sep. 25, 2000 (JP) 2000-290424

(51) Int. Cl. H04M 1/00

(52) U.S. Cl. 455/565; 455/564; 455/550

(57) ABSTRACT

A light emitting diode is provided. In reply to acceptance of a key operation in a key unit, the CPU instructs the light emitting diode to light up before the result of the process in compliance with the key operation is displayed on the LCD.

### CROSS-REFERENCE TO RELATED APPLICATIONS

This application is based upon and claims the benefit of priority from the prior Japanese Patent Application No. 2000-290424, filed Sep. 25, 2000, the entire contents of which are incorporated herein by reference.

### BACKGROUND OF THE INVENTION

1. Field of the Invention

The present invention relates to a portable terminal such as a mobile communication terminal (hereinafter “terminal”) or a PDA (personal digital assistant).

2. Description of the Related Art

A conventional terminal notifies the user each time he or she presses a key by sounding a key tone, and this tone confirm that the key operation has been accepted.

Recently, there are increasing cases where the terminal is used for purposes other than voice communication, namely, connection to the Internet and communication by e-mail. In the case of voice communication, the user has to consider the time and place where the terminal can be used, and sometimes he or she must refrain from using it since voice communications may cause annoyance in public places where people gather, such as inside of a train, a hotel lobby and a restaurant, especially when it is quiet there. However, in the case of connection to the Internet, e-mail or the like, speech is not necessary, so no annoyance is caused to others, and therefore the terminal can be used in such places and times as described above.

However, still in these usages, the key tone, which sounds each time a key is pressed, causes annoyance to those close to the user. To solve this, the present terminal has been proposed, which is equipped with a function of inhibiting the key tone, if the user selects such a function. With this function, the annoyance caused to surrounding people with the key tone can be avoided.

Here, when the key tone is turned off, the user cannot perceive whether or not the key operation is properly input to the terminal until the communication device executes the processing in accordance with the key operation and displays the result of the processing. Sometimes, it may take a long time to execute a processing depending upon the contents of the processing requested by a key operation. Therefore, there may result a large time lag between the time of a key operation and the time when a user can confirm that the key operation inputted is accepted by the terminal. As the time lag increases, some drawbacks result. That is, the user is likely to feel a deterioration in the usability of the terminal and the possibility of erroneous operations, such as a key is pressed an unnecessary number of times, is increased.

Such drawbacks are not unique to the case of the terminals, but prone to portable terminals such as PDAs, and other types of devices which utilize inputting means such as keyboard.

### BRIEF SUMMARY OF THE INVENTION

The object of the present invention is to provide a portable terminal which enables a user to perceive an input operation quickly and accurately without causing annoyance to surrounding people.

The object can be realized by a portable terminal comprising:

a keypad configured to accept an operation by a user; a display; a processor configured to execute a processing in compliance with the user's operation accepted through the keypad, and to display a result thereof on the display; a notification device configured to carry out a predetermined notification operation; and a notification controller configured to render the notification operation to perform the predetermined operation at a predetermined timing before the result of the processing is displayed on the display by the processor.

The object can be realized by a portable terminal comprising:

a keypad configured to accept an operation by a user; a display; a processor configured to execute a processing in compliance with the user's operation accepted through the keypad, and to display a result thereof on the display; and a notification controller configured to render the display to display a predetermined notification image irrelevant to a result of the processing at a predetermined timing before the result of the processing is displayed on the display by the processor.

The above-described object can be realized by a method of controlling a portable remote device, comprising:

executing a processing in compliance with the user's operation accepted through a keypad, and displaying a result thereof on the display; and controlling a predetermined notification operation at a predetermined timing before the result of the processing is displayed on the display by the processing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a structure of a mobile communication terminal according to an embodiment of the present invention;

FIG. 2 is a front-view diagram showing an appearance of the mobile communication terminal according to the embodiment of the present invention;

FIG. 3 is a flowchart for illustrating an operation of the embodiment; and

FIG. 4 is a time-chart for illustrating an operation of the embodiment.

### DETAILED DESCRIPTION OF THE INVENTION

An embodiment of a mobile communication terminal (hereinafter “terminal”) to which the present invention is applied will now be described in detail with reference accompanying drawings.

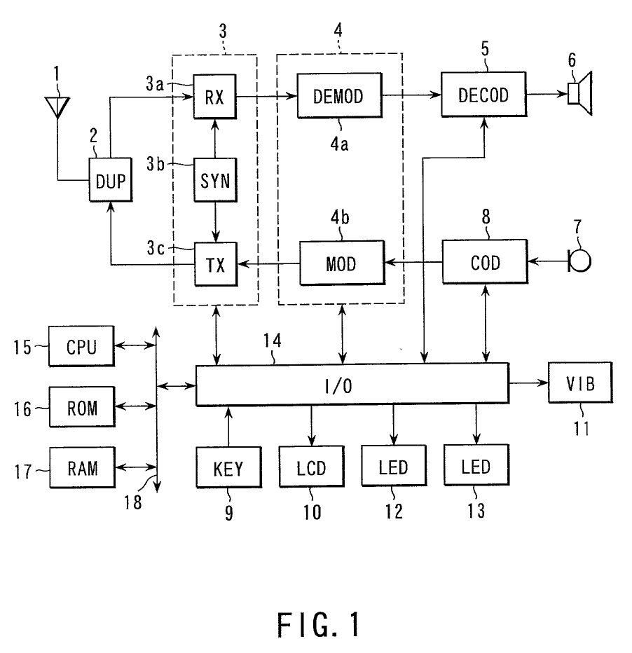

FIG. 1 is a block diagram showing a structure of the terminal according to this embodiment.

As shown in this figure, the terminal of this embodiment includes an antenna 1, duplexer (DUP) 2, a radio unit 3, a modulation/demodulation unit 4, a decoder (DECOD) 5, a speaker 6, a microphone 7, a coder (COD) 8, a key unit (KEY) 9, a liquid crystal display (LCD) 10, a vibrator (VIB) 11, light-emitting diodes (LEDs) 12 and 13, an I/O unit 14, a CPU 15, a ROM 16 and a RAM 17.

A radio signal transmitted from a base station (not shown) is received through the antenna 1 and then inputted to the radio unit 3 via the duplexer 2. In the radio unit 3, the radio signal is inputted to a reception circuit (RX) 3a, in which the signal is mixed with a local signal outputted from a frequency synthesizer (SYN) 3b and is frequency-converted into a mid-frequency signal. It should be noted here that the local signal generated from the frequency synthesizer 3b is set in compliance with an instruction from the CPU 15.

The mid-frequency signal thus received is inputted to the modulation/demodulation unit 4. The modulation/demodulation unit 4 subjects the received mid-frequency signal to digital-demodulation in a digital demodulator (DEMOD) 4a so as to convert it into demodulation data. The demodulation data is inputted to the decoder 5. The decoder 5 carries out a decoding process on the demodulation data, and thus reproduces an analog receive signal of a base band or received packet data. Then, the decoder 5 send the analog receive signal to the speaker 6. Thus, the speaker 6 outputs sound on the basis of the analog receive signal. The decoder 5 outputs the reproduced receive packet data to the CPU 15 via the I/O unit 14.

Meanwhile, an input sound signal of a speaker inputted through the microphone 7 is sent to the coder 8. An input sound signal made by a speaker inputted to the microphone 7 is sent to the coder 8. The input sound signal is subjected to a PCM-coding process by the coder 8, and then inputted as sound data to the modulation/demodulation unit 4. The transmission packet data such as e-mail formed by the CPU 15 is encoded by the coder 8, and then inputted to the modulation/demodulation unit 4.

The modulation/demodulation unit 4 modulates a carrier signal in a digital modulator (MOD) 4b on the basis of transmit sound data or transmit packet data outputted from the coder 8, and thus a mid-frequency transmission signal is obtained.

A transmission circuit (TX) 3c convert the frequency of the mid-frequency transmission signal by synthesizing it with a transmission local signal generated from a frequency synthesizer 3b, and thus converts it into a transmission radio frequency signal. The transmission radio frequency signal outputted from a transmission circuit 2d is supplied to the antenna 1 via the duplexer 2, and then transmitted to a base station being connected, from the antenna 1.

A key unit 9 includes a number of key switches which function as a dial key, a transmission key, a power key, an end key, a volume control key, a mode selection key and the like, respectively. The key unit 9 accepts operations by the user as a key switch is pressed. In other words, the key unit 9 serves as a keypad.

The LCD 10 displays various data to be notified to the user, under control of the CPU 15. The LCD 10 is also used to display the result of the processing executed by the CPU 15 in response to the user's operation, and it corresponds to a display.

The vibrator 11 vibrates under the control of the CUP 15, so as to notify the user.

The light emitting diodes 12 and 13 each emit light under the control of the CPU 15. The light emitting diodes 12 and 13 are controlled to emit light in response to a key operation inputted through the key unit 9 as will be described later, and it corresponds to a light emitting device for notification.

To the I/O unit 14, the radio unit 3, the modulation/demodulation unit 4, the decoder 5, the coder 8, the key unit 9, the LCD 10, the vibrator 11 and the light emitting diodes 12 and 13 are connected. Further, the bus 18 is connected to the I/O unit 14. The I/O unit 14 generates a control signal for activate a respective section on the basis of a respective command given from the CPU 15, and outputs thereto. The I/O unit 14 converts a signal to be outputted to the CPU 15 from a respective unit, into a command signal which can be handled by the CPU 15, and then give the converted command to the CPU 15 via the bus 18.

The CPU 15 operates on the basis of the program stored in the ROM 16, and thus controls the respective unit so as to realize the operation as a terminal.

The ROM 16 stores the above-mentioned programs and various data used by the CPU 15, etc.

The RAM 17 stores various kinds of data including various setting data, received mail data and received image data, as well as mail data and image data formed in the device itself.

The CPU 15 executes software processing on the basis of the program stored in the ROM 16, and in this manner, the CPU 15 is capable of functioning as a control section for executing generally known functions as a terminal, as well as a processor and a notification controller.

The processor executes the processing in compliance with the user's operation input via the key unit 9.

The notification controller renders the LEDs 12 and 13 to emit light so as to notify the user that the user's operation using the key unit has been accepted.

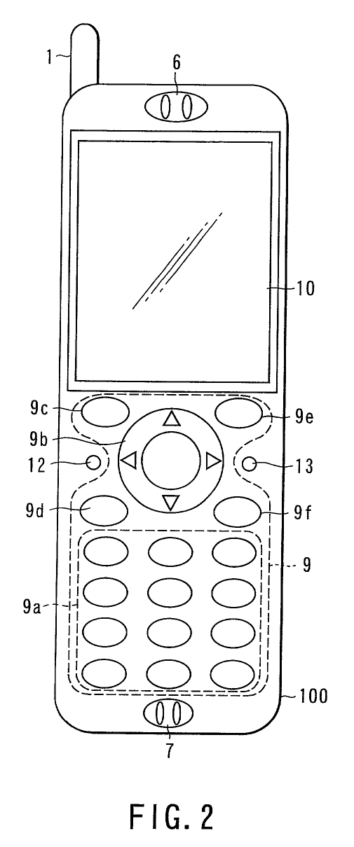

FIG. 2 is a front view showing the structure of an enclosure of a terminal. In this figure, those structural elements which are similar to those shown in FIG. 1 are designated by the same reference numerals.

As shown in this figure, the antenna 2 is provided to project from an enclosure 100. A front surface of the enclosure 100 is equipped with the speaker 6, the microphone 7, the LCD 10, the key unit 9 and the light emitting diodes 12 and 13.

The key unit 9 includes a dial key 9a, a multifunction key 9b and function keys 9c, 9d, 9e and 9f, which are arranged as illustrated in the figure. The light emitting diodes 12 and 13 are arranged at such relative positions with respect to each key of the key unit 9 and the LCD 10 as shown in the figure. More specifically, the light emitting diodes 12 and 13 are both situated between the dial key 9a and the LCD 10. The light emitting diodes 12 and 13 are situated on both sides of the multi-function key 9b.

The operation of a terminal having the above-described structure will now be described.

It should be noted first that voice communication, connection to the Internet and transmission and reception of e-mails are performed in a similar manner to that of the conventionally known terminals, and therefore the explanations of these operations will be omitted here. Here, the operation of the device at the time of inputting user's operations will now be described in detail.

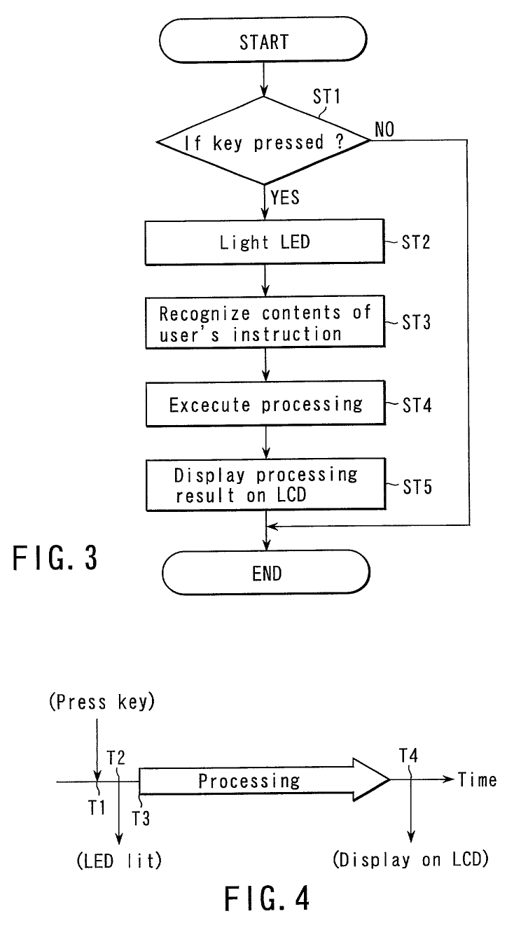

While the terminal is in a state of accepting a user's operation, the CPU 15 executes a process for accepting the user's operation as shown in FIG. 3 at a predetermined timing, such as at predetermined time intervals.

When this processing is started, the CPU 15 first confirms if any key of the key unit 9 has been pressed (step ST1). When it is confirmed that no key has been pressed, the CPU ends the processing.

On the other hand, when it is confirmed that a key has been pressed, the CPU 15 immediately lights the LEDs 12 and 13 (step ST2). Here, the lighting time for the light emitting diodes 12 and 13, although it may be arbitrary, should preferably be determined to assure some time so that the user can recognize the light emission of the light emitting diodes 12 and 13. At the same time, in order to avoid wasteful power consumption, it is desirable that the lighting time for the light emitting diodes 12 and 13 should be set as short as possible within a range where the above-described conditions are satisfied. Further, it is necessary to notify the user on the basis of the next key operation, and therefore the lighting time of the light emitting diodes 12 and 13 should be set short. That is, for example, the lighting should be finished before the processing in a step ST5, which will be later described.

After that, the CPU 15 recognizes the contents of the user's instruction inputted by pressing a key as described above (step ST3), and executes the processing in compliance with the user's instruction (step ST4). When the processing in the step ST4 is finished, the CPU 15 renders the LCD 10 to display the result of the processing (step ST5).

In this manner, according to this embodiment, as shown in FIG. 4, after a point of time T1 when a key is pressed by the user, and before a point of time T3 when the processing in compliance with the key operation is started, the light emitting diodes 12 and 13 light up at a point of time T2. Thus, it is possible for the user to recognize that the key operation has been accepted by monitoring the lights of the diodes 12 and 13 with his or her eyes before the result of the processing is displayed on the LCD 10 at a point of time T4. As described, the notification to the user is made only by the lighting of the light emitting diodes 12 and 13, and this notifying operation does not involve any sound. Therefore, no annoyance is caused to surrounding persons.

Further, according to this embodiment, the light emitting diodes 12 and 13 are lit up instantaneously when a key is pressed. Therefore, when the user tries to press a key, he or she can confirm immediately whether or not the key operation has been accepted by monitoring if the diodes 12 and 13 are lit up immediately after the pressing of the key. In this manner, the user can easily perform an input operation while confirming whether or not a key operation is accepted each time a key is pressed, especially in the case where a great number of numerals and/or characters are continuously inputted such as when inputting a telephone number or preparing an e-mail.

When the user presses a key, he or she looks at the device in hand, more specifically, the key unit 9 or the LCD 10. In this embodiment, the light emitting diodes 12 and 13 are arranged between the dial key 9a and the LCD 10. With this arrangement, the user can confirm the lighting of the light emitting diodes 12 and 13 while monitoring either one of the key unit 9 and the LCD 10.

Further, according to this embodiment, two diodes, that is, the light emitting diodes 12 and 13 are provided to be both lit up. With this arrangement, even if one light emitting diode is hidden from the user's view with his or her finger or the like, the user can confirm the other diode lighting up.

It should be noted that the present invention is not limited to the described embodiment. For example, in the embodiment described above, the light emitting diodes 12 and 13 are set to be lit up instantaneously after a key is pressed. However, the timing for lighting the light emitting diodes 12 and 13 may be arbitrary as long as it is within a time range form the point when a key is pressed, to the point when the result of the processing in compliance with the key operation is displayed.

In this embodiment, the notification indicating that a key operation has been accepted, can be reported by the lighting up the light emitting diodes 12 and 13. However, as an operation mode for notifying the acceptance of a key operation, it is possible to prepare at least one of an operation mode for notifying the user only with the sound of a confirmation tone, another operation mode for notifying the use with both the lighting of the light emitting diodes 12 and 13 and the sound of the confirmation tone, and still another operation mode which does not perform both the lighting of the light emitting diodes 12 and 13 and the sound of the confirmation tone, and use one of these operation modes selected by the user.

Further, in this embodiment, there are two light emitting diodes 12 and 13; however the number of diodes may be one or three or more.

Furthermore, in this embodiment, the two light emitting diodes 12 and 13 are both lit up. However, it is alternatively possible that the user selects either one of the diodes 12 and 13 to be lit up, and only the selected one is lit up as so set by the user. In this manner, a wasteful power consumption can be prevented.

The location where the light emitting diodes 12 and 13 is not limited to the side illustrated in this embodiment. As long as the user can recognize the lighting, the location may be arbitrary.

Further, as the notification device, some other light emitting device than the light emitting diodes 12 and 13 may be used.

In this embodiment, the light emitting diodes 12 and 13 are provided exclusively as a notification device. However, a light emitting device such as the key illumination lamp, the incoming signal lamp or the backlight of the LCD 10, which are provided for some other purposes, may be applied.

In this embodiment, the light emitting devices such as the light emitting diodes 12 and 13 are used as the notification device. Alternatively, the display device such as the LCD 10 or the vibrator 11 may be used as the notification device.

Further, in this embodiment, the key unit 9 is used as the keypad. However, some other type such as a touch panel can be used as a keypad.

The embodiment is described in connection with a case where the present invention is applied to a terminal. However, the present invention can be applied to some other types of terminal devices including PDA.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable terminal comprising:
a keypad configured to accept an operation by a user;
a display;
a processor configured to execute a processing in compliance with the user's operation accepted through the keypad, and to display a result thereof on the display;
a notification device configured to carry out a predetermined notification operation; and
a notification controller configured to render the notification operation to perform the predetermined operation at a predetermined timing before the result of the processing is displayed on the display by the processor.

2. The portable terminal according to claim 1, wherein the keypad is a key unit provided with at least one key switch.

3. The portable terminal according to claim 1, wherein the keypad at least accepts a user's operation that designates a numeral.

4. The portable terminal according to claim 1, wherein the notification device is a light emitting device that emits light as the notification operation.

5. The portable terminal according to claim 4, wherein the light emitting device is a light emitting diode.

6. The portable terminal according to claim 4, wherein the light emitting device is located between the keypad and the display device.

7. The portable terminal according to claim 1, wherein the notification device is a vibrator that vibrates as the notification operation.

8. The portable terminal according to claim 1, wherein the notification controller sets the predetermined timing at immediately after the user's operation has been accepted by the keypad.

9. A portable terminal comprising:
a keypad configured to accept an operation by a user;
a display;
a processor configured to execute a processing in compliance with the user's operation accepted through the keypad, and to display a result thereof on the display; and
a notification controller configured to render the display to display a predetermined notification image irrelevant to a result of the processing at a predetermined timing before the result of the processing is displayed on the display by the processor.

10. A method of controlling a portable remote device, comprising:
executing a processing in compliance with the user's operation accepted through a keypad, and displaying a result thereof on the display; and
controlling a predetermined notification operation at a predetermined timing before the result of the processing is displayed on the display by the processing.
